(19) United States
(12) Patent Application Publication
(10) Pub. No.: US 2018/0294458 A1
(43) Pub. Date: Oct. 11, 2018

(54) HIGHLY HEAT RESISTANT AND FLAME RETARDANT SEPARATOR, AND ELECTROCHEMICAL CELL

(71) Applicant: SAMSUNG SDI CO., LTD., Yongin-si, Gyeonggi-do (KR)

(72) Inventors: Chang Hong KO, Suwon-si (KR); Dong Wan SEO, Suwon-si (KR); Mok Yun JIN, Suwon-si (KR)

(21) Appl. No.: 15/570,673

(22) PCT Filed: Apr. 22, 2016
(86) PCT No.: PCT/KR2016/004250

§ 371 Date: Oct. 30, 2017

(30) Foreign Application Priority Data
Apr. 29, 2015 (KR) 10-2015-0060514

(51) Int. Cl. H01M 2/16; H01M 2/14; H01M 10/052

(52) U.S. Cl. CPC H01M 2/1686; H01M 2/1653; H01M 10/052; H01M 2/145; H01M 2/166

(57) ABSTRACT

The present invention relates to: a separator comprising a porous substrate, and a heat resistant porous layer on one or both surfaces of the porous substrate, wherein the heat resistant porous layer comprises a cross-linked product of a cross-linkable functional group-containing phosphate-based or phosphonate-based monomer, oligomer, or polymer; an electrochemical cell comprising the same; or a method for preparing the separator.

### TECHNICAL FIELD

The present disclosure relates to a highly heat resistant and flame retardant separator and an electrochemical cell including the same.

### BACKGROUND ART

A separator for an electrochemical cell means an interlayer separating a positive electrode and a negative electrode in a cell and also steadily maintaining ion conductivity to enable the cell to be charged and discharged.

Recently, the cell is required to have a high power/large capacity in order to be employed for an electric vehicle or the like in addition to the tendency of light weight and down size of the electrochemical cell for a portable electronic device. A lithium rechargeable cell providing a high power with respect to a capacity has been researched as a unit cell (battery cell) for a medium-large cell pack for the high power/large capacity usage.

For the variety of merits, a lithium rechargeable cell is a strong candidate of a medium-large cell pack, but it may causes problems in that the internal temperature of the cell is increased when being charged and discharged, and it may be exploded or fired by generating a combustible gas caused by a decomposition of an electrolyte, a combustible gas caused by a reaction between an electrolyte and an electrode, and oxygen caused by a decomposition of a positive electrode, and the like. In addition, when polyolefin-based is used for a substrate film of a separator of a rechargeable cell, it causes a problem in that the film is melted down at a relatively low temperature (Korean Patent No. 10-0775310).

Accordingly, it is required to provide a novel separator improving or maintaining inherent performances of the cell as well as preventing or suppressing ignition in an electrochemical cell, particularly, a medium-large capacity cell and improving heat resistance and anti-oxidation.

### DISCLOSURE

### Technical Problem

The present disclosure has a purpose to provide a separator having flame retardance, antioxidation, and high heat resistance, and excellent adherence to a substrate film and an electrochemical cell using the same.

### Technical Solution

In an example embodiment of the present invention, provided is a separator comprising a porous substrate, and a heat resistant porous layer on one or both surfaces of the porous substrate, wherein the heat resistant porous layer comprises a cross-linked product of a cross-linkable functional group-containing phosphate-based or phosphonate-based monomer, oligomer, or polymer.

Another example embodiment of the present invention provides a separator including a porous substrate and a heat resistant porous layer formed on one or both surfaces of the porous substrate, wherein the separator has an electrolyte solution shrinkages at a width direction and a length direction at 150° C. and 60 minutes are each less than or equal to 45% and a flame retardancy of greater than or equal to V2 according to UL94 VB flame-retardance regulations.

In addition, another example embodiment of the present invention provides an electrochemical cell formed from the separators according to the example embodiments.

Another example embodiment of the present invention provides a method of preparing a separator comprising: preparing a heat resistant porous layer composition comprising a cross-linkable functional group-containing phosphate-based or phosphonate-based monomer, oligomer, or polymer, a polymerization initiator, and a solvent, and coating the heat resistant porous layer composition on one or both surfaces of the porous substrate and performing a cross-linking reaction to form a heat resistant porous layer.

### Advantageous Effects

The separator according to an example embodiment of the present invention and the electrochemical cell using the same may have flame retardance, antioxidation and high heat resistance, and also have merits of excellent adherence to a porous substrate and a heat resistant porous layer and good properties of air permeability, puncture strength, fracture strength, electrolyte solution shrinkage, and the like.

### DESCRIPTION OF THE DRAWINGS

FIG. 1 is an exploded perspective view of an electrochemical cell according to an embodiment.

### MODE FOR INVENTION

Hereinafter, embodiments of the present invention are described in detail. However, these embodiments are exemplary, the present invention is not limited thereto and the present invention is defined by the scope of claims.

In the present specification, when a definition is not otherwise provided, ‘substituted’ refers to replacement of hydrogen of a compound by a substituent selected from a halogen atom (F, Br, Cl, I), halogenated alkyl, a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, C₁ to C₂₀ alkyl group, C₂ to C₂₀ alkenyl group, C₂ to C₂₀ alkynyl group, C₆ to C₃₀ aryl group, C₇ to C₃₀ arylalkyl group, C₁ to C₂₀ alkoxy group, C₁ to C₂₀ heteroalkyl group, C₃ to C₂₀ heteroarylalkyl group, C₃ to C₂₀ cycloalkyl group, (meth)acrylate group, C₃ to C₂₀ cycloalkenyl group, C₄ to C₂₀ cycloalkynyl group, C₂ to C₂₀ heterocycloalkyl group, and a combination thereof.

In addition, in the present specification, when a definition is not otherwise provided, ‘hetero’ refers to inclusion of 1 to 3 heteroatom selected from N, O, S, and P.

According to an example embodiment of the present invention, provided is a separator comprising a porous substrate, and a heat resistant porous layer formed on one or both surfaces of the porous substrate, wherein the heat resistant porous layer comprises a cross-linked product of a cross-linkable functional group-containing phosphate-based or phosphonate-based monomer, oligomer, or polymer.

The porous substrate may have a plurality of pores and may generally be a porous substrate used in an electrochemical device. Non-limiting examples of the porous substrate may be a polymer film formed of a polymer selected from the group consisting of polyethylene, polypropylene, polyethyleneterephthalate, polybutyleneterephthalate, polyester, polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylenesulfide, and polyethylenenaphthalene or a mixture of two or more selected therefrom. In one example, the porous substrate may be a polyolefin-based substrate and the polyolefin-based substrate may improve has safety of a cell due to its improved shut-down function. The polyolefin-based substrate may be for example selected from the group consisting of a polyethylene single film, a polypropylene single film, a polyethylene/polypropylene double film, a polypropylene/polyethylene/polypropylene triple film, and a polyethylene/polypropylene/polyethylene triple film. In another example, the polyolefin-based resin may include a non-olefin resin in addition to an olefin resin or a copolymer of olefin and a non-olefin monomer. A thickness of the porous substrate may be 1 μm to 40 μm, specifically 5 μm to 20 μm, or more specifically 5 μm to 16 μm. When using the substrate film within the thickness range, it may provide a separate having a suitable thickness which is thick enough to prevent a short of the positive electrode and the negative electrode but is not thick to increase internal resistance of the cell. The porous substrate may have air permeability of less than or equal to 250 sec/100 cc, specifically, less than or equal to 200 sec/100 cc, more specifically, 150 sec/100 cc and a porosity of 30% to 80%, specifically, 40% to 60%.

The heat resistant porous layer may be formed of a heat resistant porous layer composition, and specifically, by coating a heat resistant porous layer composition including a cross-linkable functional group-containing phosphate-based or phosphonate-based monomer, oligomer, or polymer, a polymerization initiator, a solvent on one or both surfaces of the porous substrate and performing a cross-linking reaction. Accordingly, the separator according to an example embodiment of the present invention may include a cross-linked product of the cross-linkable functional group-containing phosphate-based or phosphonate-based monomer, oligomer, or polymer as a component of the heat resistant porous layer formed on one or both surfaces of the porous substrate.

As the cross-linked product includes the phosphate-based or phosphonate-based derived material, it may prevent that the cell is exploded or fired caused by generating oxygen caused by decomposing positive electrode, and it may improve physical stability such as heat resistance and puncture strength, fracture strength and the like due to the cross-linking reaction among the cross-linkable functional groups or between the cross-linkable functional group and the multi-functional (meth)acrylate.

Without being bound by any particular theory, the phosphate-based or phsophonate-based structure may generate polymetaphosphoric acid by thermal decomposition. The generated polymetaphosphoric acid may form a protective layer on the separator or block oxygen by a carbon coating layer produced while dehydration in preparing polymetaphosphoric acid to provide flame retardance.

The separator according to an example embodiment of the present invention may have advantages of ensuring sufficient adherence to the separator substrate, suppressing ignition, and ensuring physical strength and heat resistance simultaneously by including the cross-linked product of the cross-linkable functional group-containing phosphate-based or phosphonate-based monomer, oligomer, or polymer in the heat resistant porous layer as described above.

In an example embodiment of the present invention, examples of the cross-linkable functional group-containing phosphate-based or phosphonate-based monomer, oligomer, or polymer are as follows.

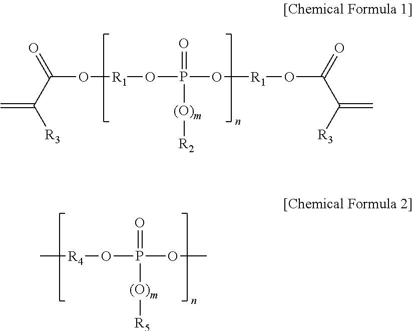

In Chemical Formula 1 or 2,

R₁ and R₄ are independently selected from a substituted or unsubstituted, C₁₋₁₈ alkylene, C₂₋₆ alkenylene, C₃₋₁₂ cycloalkylene, and C₆₋₃₀ aromatic containing group,

R₂, R₃, and R₅ are independently selected from a substituted or unsubstituted, hydrogen, C₁₋₁₈ alkyl, C₂₋₆ alkenyl, C₃₋₁₂ cycloalkyl, C₆₋₃₀ aromatic containing group, and halogen atom,

n is an integer ranging from 1 to 1000, and

m is 0 or 1.

In one specific example, in Chemical Formula 1 or Chemical Formula 2, R₁ and R₄ may independently be a substituted or unsubstituted C₆₋₃₀ aromatic containing group, R₂ and R₅ may independently be a substituted or unsubstituted C₆₋₃₀ aromatic containing group or a halogen atom, R₃ may be a substituted or unsubstituted, hydrogen, a halogen atom, or C₁₋₁₈ alkyl, and m may be 0. In one specific example, in Chemical Formula 2, the cross-linkable functional group may be introduced into at least one of each substituent of R₄ and R₅.

In the definition of Chemical Formula 1 or 2, the C₆₋₃₀ aromatic containing group may be once or more substituted or unsubstituted aromatic hydrocarbon cyclic containing group and may be, for example, a residual group where aromatic hydrocarbon is alone, two or more aromatic hydrocarbons are fused with each other to form a condensed ring, or two or more aromatic rings are linked directly or by another linking group.

In the definition of Chemical Formula 1 or 2, the C₁₋₁₈ alkylene or the C₁₋₁₈ alkyl may refer to a linear or branched C₁₋₁₈ alkyl or alkylene, and may be for example, methyl, 1-methylethyl, 1-methylpropyl, 2-methylpropyl, 1,1-dimethylethyl, 1-methylbutyl, ethyl, n-propyl, isopropyl, n-butyl, t-butyl, isobutyl, sec-butyl, pentyl, n-hexyl, n-heptyl, or n-octyl, and the like.

In the definition of Chemical Formula 1 or 2, the C₂₋₆ alkenylene or the C₂₋₆ alkenyl may refer to a linear or branched C₂₋₆ alkenyl or alkenylene including a carbon double bond, and may be for example, 1-propenyl, 2-propenyl, 2-methyl-1-propenyl, 1-butenyl, 2-butenyl, and the like.

In the definition of Chemical Formula 1 or 2, the C₃₋₁₂ cycloalkyl or cycloalkylene may refer to a C₃₋₁₂ saturated hydrocarbon cycle, and may be for example, a cyclopropyl, cyclobutyl, cyclopentyl, cyclohexyl or cyclopentyl methyl group.

Specifically, in the R₁ and R₄ substituents of Chemical Formula 1 and 2, the C₆₋₃₀ aromatic containing group may be selected from the group consisting of Chemical Formulae A1 to A42:

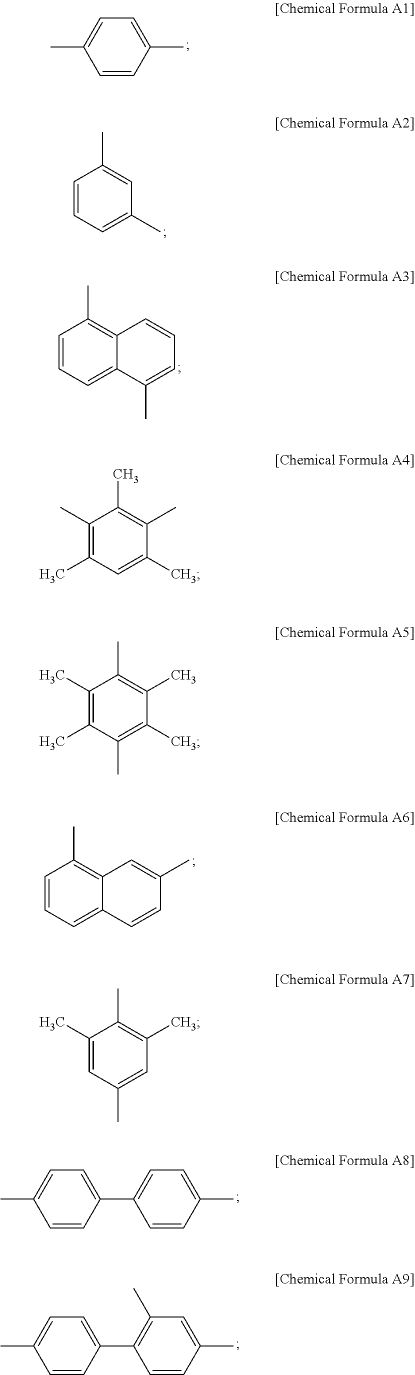

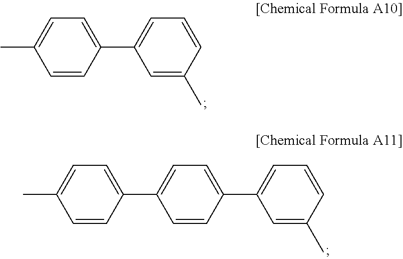

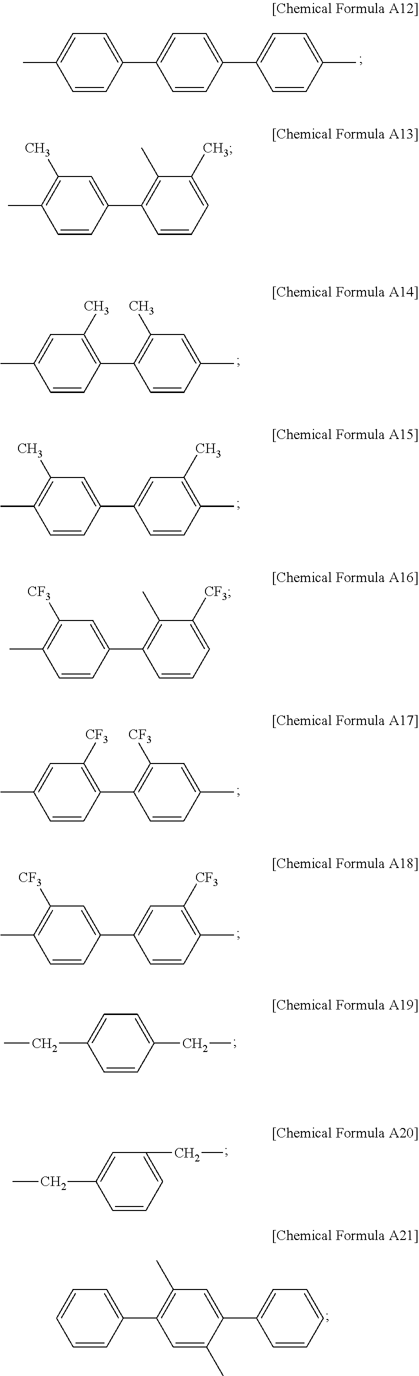

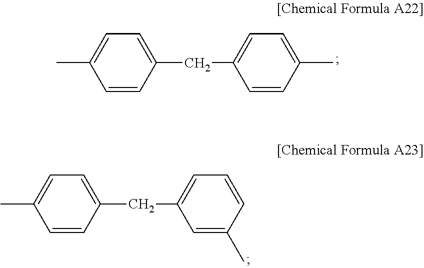

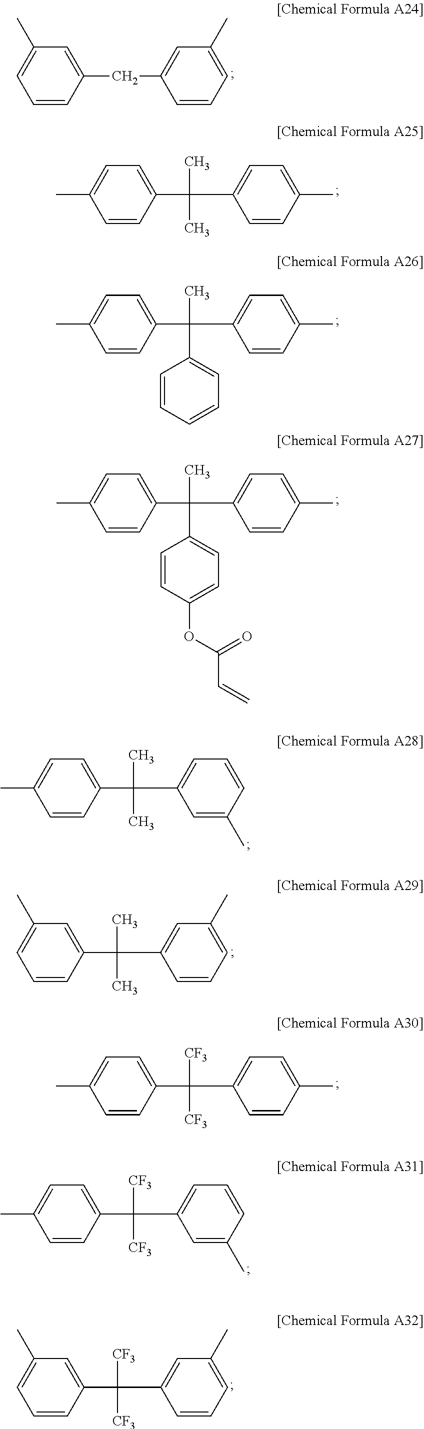

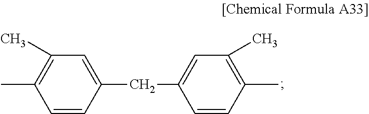

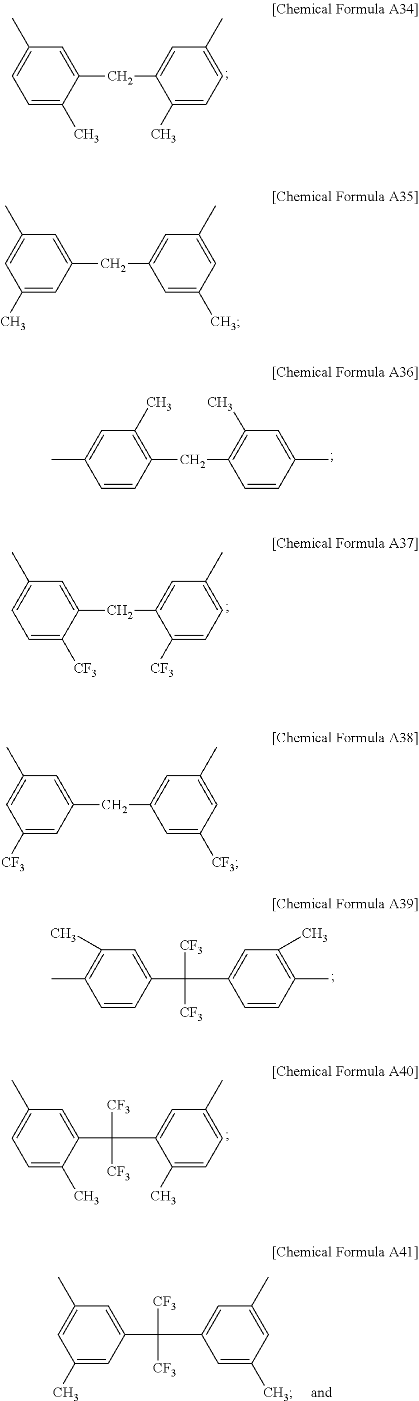

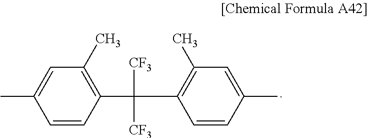

The C₆₋₃₀ aromatic containing group may be explained as an example of a divalent group, but the C₆₋₃₀ aromatic containing group may correspond to examples of R₂, R₃, and R₅ as a form of a monovalent substituent.

The cross-linkable functional group in the phosphate-based or phosphonate-based monomer, oligomer, or polymer may be greater than or equal to 1, specifically, greater than or equal to 2. In one example, the cross-linkable functional group may be introduced into each substituent of R₁ to R₅ in monomer, oligomer, or polymer of Chemical Formula 1 or 2. In one example, the cross-linkable functional group may be a (meth)acrylate group.

The molecular weight of the cross-linkable functional group-containing phosphate-based or phosphonate-based monomer, oligomer, or polymer may range from 500 to 500,000, specifically from 1,000 to 200,000, more specifically from 1,000 to 100,000. Within the range, it may be preferable in a view of flame retardance and adhering strength.

The cross-linkable functional group-containing phosphate-based or phosphonate-based monomer, oligomer, or polymer may be included in 2 wt % to 100 wt %, for example, 5 wt % to 70 wt % based on the total solid weight of the heat resistant porous layer composition of the separator. In more specific examples, it may be included in 5 wt % to 60 wt %. Within the range, heat resistance, impact strength, flame retardance or the like may be all good.

The polymerization initiator may be, for example, a peroxide-based or azo-based initiator. Specific examples of the peroxide-based initiator may be t-butyl peroxylaurate, 1,1,3,3-t-methylbutylperoxy-2-ethyl hexanoate, 2,5-dimethyl-2,5-di(2-ethylhexanoyl peroxy) hexane, 1-cyclohexyl-1-methylethyl peroxy-2-ethyl hexanoate, 2,5-dimethyl-2,5-di(m-toluoyl peroxy) hexane, t-butyl peroxy isopropyl monocarbonate, t-butyl peroxy-2-ethylhexyl monocarbonate, t-hexyl peroxy benzoate, t-butyl peroxy acetate, dicumyl peroxide, 2,5,-dimethyl-2,5-di(t-butyl peroxy) hexane, t-butyl cumyl peroxide, t-hexyl peroxy neodecanoate, t-hexyl peroxy-2-ethyl hexanoate, t-butyl peroxy-2-2-ethylhexanoate, t-butyl peroxy isobutyrare, 1,1-bis(t-butyl peroxy)cyclohexane, t-hexyl peroxyisopropyl monocarbonate, t-butyl peroxy-3,5,5-trimethyl hexanoate, t-butyl peroxy pivalate, cumyl peroxy neodecanoate, di-isopropyl benzene hydroperoxide, cumene hydroperoxide, isobutyl peroxide, 2,4-dichloro benzoyl peroxide, 3,5,5-trimethyl hexanoyl peroxide, octaniyl peroxide, lauryl peroxide, stearoyl peroxide, succin peroxide, 3,5,5-trimethyl hexanoyl peroxide, benzoyl peroxide, benzoyl peroxy toluene, 1,1,3,3-tetramethyl butyl peroxy neodecanoate, 1-cyclohexyl-1-methyl ethyl peroxy nodecanoate, di-n-propyl peroxy dicarbonate, di-isopropyl peroxy carbonate, bis (4-t-butyl cyclohexyl) peroxy dicarbonate, di-2-ethoxy methoxy peroxy dicarbonate, di (2-ethyl hexyl peroxy) dicarbonate, dimethoxy butyl peroxy dicarbonate, di (3-methyl-3-methoxy butyl peroxy) dicarbonate, 1,1-bis(t-hexylperoxy)-3,3,5-trimethyl cyclohexane, 1,1-bis(t-hexyl peroxy) cyclohexane, 1,1-bis(t-butyl peroxy)-3,3,5-trimethyl cyclohexane, 1,1-(t-butyl peroxy) cyclododecane, 2,2-bis(t-butyl peroxy)decane, t-butyl trimethyl silyl peroxide, bis(t-butyl) dimethyl silyl peroxide, t-butyl triallyl silyl peroxide, bis(t-butyl) diallyl silyl peroxide, tris(t-butyl) aryl silyl peroxide, and the like.

Specific examples of the azo-based initiator may be 2,2′-azobis (4-methoxy-2,4-dimethyl valeronitrile), dimethyl 2,2′-azobis (2-methyl propionate), 2,2′-azobis(N-cyclohexyl-2-methyl propionate), 2,2-azobis (2,4-dimethylvaleronitrile), 2,2′-azobis (2-methyl butyronitrile), 2,2′-azobis[N-(2-propenyl)-2-methylpropionate], 2,2′-azobis(N-butyl-2-methyl propionate), 2,2′-azobis[N-(2-propenyl)-2-methyl propionate], 1,1′-azobis(cyclohexane-1-carbonitrile), 1-[(cyano-1-methylethyl)azo] formamide, and the like, but are not limited thereto.

The polymerization initiator may be used in a range of about 0.5 wt % to about 20 wt %, for example, about 1 wt % to about 15 wt %, or about 1 wt % to about 10 wt % based on the total weight of the heat resistant porous layer composition.

Hereinafter, a separator according to another example embodiment of the present invention will be described. The separator according to the present example embodiment may include a cross-linked product of a cross-linkable functional group-containing phosphate-based or phosphonate-based monomer, oligomer, or a polymer and a multi-functional (meth)acrylate in the heat resistant porous layer. Due to the cross-linking reaction between the cross-linkable functional group-containing phosphate-based or phosphonate-based monomer, oligomer, or polymer and the multi-functional (meth)acrylate, it may further improve physical stability of heat resistance, puncture strength, and fracture strength, and the like of the separator. The cross-linkable functional group-containing phosphate-based or phosphonate-based monomer, oligomer, or polymer, which may be used in the present example embodiment, is substantially same as disclosed in the above-mentioned exemplary embodiment, so hereinafter, it is described focusing on the multi-functional (meth)acrylate.

The multi-functional (meth)acrylate according to an example embodiment of the present invention may be (meth)acrylate having greater than or equal to 2, for example, greater than or equal to 3, more specifically, greater than or equal to 4, for example, 4 to 8 reactive groups, wherein the reactive group may be a vinyl group, an epoxy group, a hydroxyl group, or the like, specifically, a vinyl group. In one example, by including the reactive group, it may be reacted with the cross-linking functional group in the phosphate-based or phsophonate-based monomer, oligomer, or polymer to form a cross-linking structure.

Examples of the multi-functional (meth)acrylate may be selected from dipentaerythritol penta-(meth)acrylate, pentaerythritol tri(meth)acrylate, tris (2-hydroxy-ethyl)isocyanurate tri(meth)acrylate, propoxylated triglycerol tri(meth)acrylate, pentaerythritol tetra(meth)acrylate, trimethylolethane di(meth)acrylate, trimethylolpropane di(meth)acrylate, pentaerythritol hexa(meth)acrylate, dipentaerythritol hexa(meth)acrylate, glycerine di(meth)acrylate, triethylene glycol di(meth)acrylate, t-ethylene glycol di(meth)acrylate, polyethylene glycol di(meth)acrylate, 1,3-butylene glycol di(meth)acrylate, tripropylene glycol di(meth)acrylate, ethoxy addition-type bisphenol-A di(meth)acrylate, cyclohexanedimethanol di(meth)acrylate, and a mixture of two or more.

Hereinafter, a separator according to another example embodiment of the present invention is explained. According to further another example embodiment, the heat resistant porous layer composition may further include an inorganic particle. The kind of the inorganic particle included in the heat resistant porous layer is not particularly limited, but may use inorganic particles generally used in the art. Non-limiting examples of the inorganic particle may be Al₂O₃, SiO₂, B₂O₃, Ga₂O₃, TiO₂, or SnO₂. They may be used in a single or a mixture of two or more kinds thereof, for example, Al₂O₃ (alumina) may be used. Inorganic particles in the heat resistant porous layer may act as a kind of spacer capable of maintaining a physical shape of the heat resistant porous layer. The size of the inorganic particle is not particularly limited, but the average particle diameter thereof may be 100 nm to 1000 nm, specifically, 300 nm to 600 nm. When using the inorganic particle within the size range, it may prevent that the dispersion of the inorganic particle in the heat resistant porous layer composition liquid and the coating processability are deteriorated, and the thickness of the heat resistant porous layer may be appropriately controlled. The inorganic particle may be included in 50 wt % to 98 wt % in the heat resistant porous layer, specifically, may be included in 70 wt % to 95 wt %. Within the range, it may ensure the shape stability of the separator and provide sufficient adherence between the heat resistant porous layer and the film to suppress the film shrinkage due to heat and also effectively prevent electrode short.

Hereinafter, a separator according to another example embodiment of the present invention is described. For another example, the heat resistant porous layer composition may further include another non-cross-linkable binder resin in addition to the phosphate-based or phsophonate-based monomer, oligomer, or polymer. Examples thereof may be one or a mixture selected from the group consisting of a polyvinylidene fluoride (PVdF) homopolymer, a polyvinylidene fluoride-based copolymer, polymethylmethacrylate, polyacrylonitrile, polyvinylpyrrolidone, polyvinylacetate, polyethylene oxide, cellulose acetate, cellulose acetate butyrate, cellulose acetate propionate, cyanoethylpullulan, cyanoethylpolyvinyl alcohol, cyanoethyl cellulose, cyanoethylsucrose, pullulan, carboxyl methyl cellulose, and an acrylonitrilestyrene-butadiene copolymer.

Hereinafter, a method of preparing a separator according to an example embodiment of the present invention is explained. A method of preparing a separator according to an example embodiment of the present invention comprises preparing a heat resistant porous layer composition comprising a cross-linkable functional group-containing phosphate-based or phosphonate-based monomer, oligomer, or polymer, a polymerization initiator, and a solvent, and coating the heat resistant porous layer composition on one or both surfaces of the porous substrate and performing a cross-linking reaction to form a heat resistant porous layer.

Specifically, the heat resistant porous layer may be formed by coating a heat resistant porous layer composition on one or both surfaces of the porous substrate and performing a cross-linking reaction. A method of preparing the heat resistant porous layer composition is not particularly limited, but a cross-linkable functional group-containing phosphate-based or phosphonate-based monomer, oligomer, or polymer and a polymerization initiator may be dissolved in a solvent to provide the heat resistant porous layer composition; when an inorganic particle is further added, an inorganic particle may be dispersed in the composition to provide the heat resistant porous layer composition; or the composition and inorganic particle dispersion liquid including the inorganic particle therein may be respectively prepared and may be mixed with an appropriate solvent to provide the heat resistant porous layer composition. A method of preparing the heat resistant porous layer composition may include mixing the disclosed components and a solvent, or additionally inorganic particle and agitating the same at 10 to 40° C. for 30 minutes to 5 hours.

The solvent for preparing the heat resistant porous layer composition or for preparing the inorganic particles dispersion liquid is not particularly limited as long as the solvent may dissolve each component and may sufficiently disperse inorganic particles. Non-limiting examples of the solvent usable in the present invention may be acetone, dimethyl formamide, dimethyl sulfoxide, dimethyl acetamide, dimethylcarbonate, or N-methylpyrrolidone. The amount of the solvent may be 20 wt % to 99 wt %, specifically, 50 wt % to 95 wt %, more specifically, 70 wt % to 95 wt % based on the weight of the heat resistant porous layer composition. When including the solvent within the range, the heat resistant porous layer composition is easily prepared, and a drying process of the heat resistant porous layer is smoothly performed.

A method of forming the heat resistance porous layer on the porous substrate is not particularly limited, but it may include a commonly used method in the art, for example, a coating method, a lamination, a coextrusion, and the like. Non-limiting examples of the coating method may be a dip coating method, a die coating method, a roll coating method, or a comma coating method. They may be applied in a single or in combining two or more kinds of methods. The heat resistant porous layer of the separator according to the present invention may be formed according to, for example, a dip coating method.

A thickness of the heat resistant porous layer according to example embodiments of the present invention may be 0.01 μm to 20 μm, specifically 1 μm to 15 μm, and more specifically 1 μm to 8 μm

Within the thickness range, it may provide the heat resistant porous layer with an appropriate thickness to obtain excellent thermal stability and adherence, and it may prevent that a thickness of the entire separator is excessively thick, so as to suppress that internal resistance of the cell is increased.

The cross-linking reaction may be performed by, for example, a heat-curing, a light-curing, or a high humidity and high temperature curing. The light curing reaction may include drying the separator in an oven at 50° C. to 120° C. for about 10 seconds to 60 seconds and irradiating ultraviolet (UV) ray for about 5 seconds to 100 seconds, for example, about 5 seconds to 20 seconds. The heat curing reaction may include heat-curing the separator at 20° C. to 110° C. for 1 minute to 10 days, specifically, at 30° C. to 105° C. for 1 minute to 7 days, more specifically, at 40° C. to 100° C. for 12 hours to 3 days. The high humidity and high temperature curing reaction may include curing the separator under a relative humidity condition of 10 to 80% and under a temperature condition of 60° C. to 110° C. for 1 minute to 60 minutes, specifically, for 5 minutes to 30 minutes.

In another example embodiment of the present invention, a method of preparing a separator comprises preparing a heat resistant porous layer composition comprising a cross-linkable functional group-containing phosphate-based or phosphonate-based monomer, oligomer, or polymer, multi-functional (meth)acrylate, a polymerization initiator, and a solvent, coating the heat resistant porous layer composition on one or both surfaces of the porous substrate and performing a cross-linking reaction to form a heat resistant porous layer. The heat resistant porous layer composition according to the present embodiment has a difference from the above-mentioned embodiment in that a multi-functional (meth)acrylate is further included as a porous composition, so the manufacturing method according to the above-mentioned embodiment may be applied to the present embodiment.

The another example embodiment of the present invention provides a separator including a porous substrate and a heat resistant porous layer formed on one or both surfaces of the porous substrate, wherein the separator has an electrolyte solution shrinkages at a width direction and a length direction at 150° C. and 60 minutes of each less than or equal to 45% and a flame retardancy of greater than or equal to V2 according to UL94 VB flame retardance regulations.

The electrolyte solution shrinkages at a width direction and a length direction at 150° C. and 60 minutes may be specifically each less than or equal to 40%, more specifically, less than or equal to 30%, particularly, less than or equal to 25%. As the electrolyte solution shrinkage of less than or equal to 45% decrease the separator shrinkage in the cell, it is preferable in that the cell safety may be enhanced under the high temperature atmosphere, and a method of measuring the same is as follows: the separator is cut into a width (MD) 5 cm×length (TD) 5 cm to provide total seven specimens, each specimen is dipped with 1 ml of an electrolyte solution (ex: 1.15M LiPF₆, EC/EMC/DEC=3/5/2) and then stored in a chamber at 150° C. for each 60 minutes, and then lengths at a MD direction and a TD direction of each specimen before and after the storage are measured, and a shrunk degree is measured to calculate each average electrolyte solution shrinkage (%).

The flame retardancy of the separator may be a flame retardant rate of greater than or equal to V2 when measured according to UL94 VB flame retardance regulations. Within the range, the combusting a separator is effectively prevented, so the cell safety may be improved. Specifically, the flame retardant rate may be V0, V1 or V2. A method of measuring the flame retardancy of the separator may be according to UL94 VB flame retardance regulations. Specifically, a separator is folded into 10 cm×50 cm, the upper and lower end parts are fixed to provide a specimen, and the flame retardancy rate is measured based on a combusting time of the specimen according to UL94 VB.

The air permeability of the separator including the heat resistant porous layer described in example embodiments of the present invention may be less than or equal to 400 sec/100 cc, specifically, less than or equal to 380 sec/100 cc. Within the range, ion and electron are smoothly flowed in the cell including the separator so that the cell performance may be improved.

The method of measuring the air permeability of the separator is not particularly limited, but may include the commonly-used method in the art.

A puncture strength of the separator including the heat resistant porous layer disclosed in example embodiments of the present invention may be greater than or equal to 400 gf, specifically, greater than or equal to 500 gf, more specifically, greater than or equal to 600 gf.

Non-limiting example of measuring the puncture strength is as follows: each separator is cut into width (MD) 50 mm×length (TD) 50 mm at 10 different regions to obtain 10 specimens, and then the specimen is placed over a 10 cm hole using GATO Tech G5 equipment and followed by measuring puncturing force while pressing down using a 1 mm probe. The puncture strength of each specimen is measured for each 3 times, and the average is calculated.

The separator including the heat resistant porous layer disclosed in the example embodiments of the present invention may have a fracture resistance at a high temperature of 180° C. to 300° C., specifically 200° C. to 250° C. The fracture resistance at a high temperature means that it is not suffering from fracture when each separator is cut into width (MD) 50 mm×length (TD) 50 mm at 10 different regions from each other, the specimen is placed on a plate and fixed using a tape at each 4 sides thereof, and placed in an oven at 180° C. to 300° C. and taken out after 10 minutes to check whether it is fractured or not. Thus the fracture resistance at a high temperature of 180° C. to 300° C. is preferably since a dimensional stability of the separator may be maintained when an internal temperature is sharply increased due to thermal runaway in a high-capacity cell.

According to another example embodiment of the present invention, provided is an electrochemical cell that includes a separator including the heat resistant porous layer disclosed herein, and a positive electrode, a negative electrode and is filled with an electrolyte.

The kind of the electrochemical cell is not particularly limited, and it may be the known kind of cell in the art.

The electrochemical cell according to an example embodiment of the present invention may be specifically a lithium rechargeable cell such as a lithium metal rechargeable cell, a lithium ion rechargeable cell, a lithium polymer rechargeable cell, or a lithium ion polymer rechargeable cell, and the like.

A method of fabricating the electrochemical cell according to an example embodiment of the present invention is not particularly limited, but may include the commonly used method in the art.

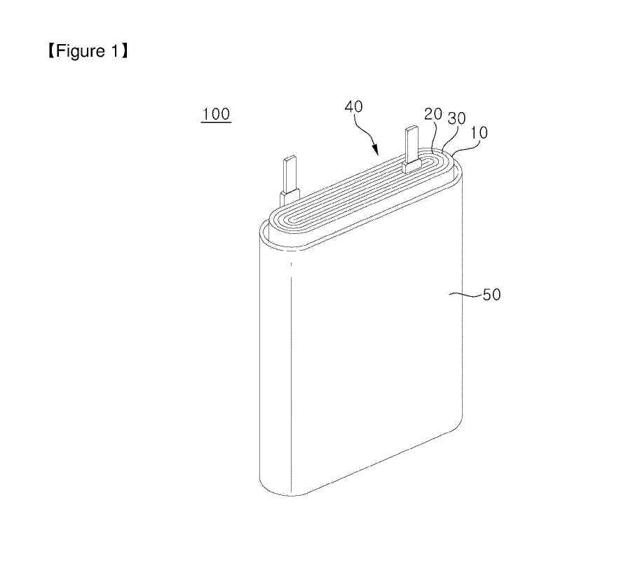

FIG. 1 is an exploded perspective view of an electrochemical cell according to an embodiment. An electrochemical cell according to an embodiment is illustrated as a prismatic cell but is not limited thereto and may include variously-shaped batteries such as a lithium polymer cell, a cylindrical cell, and the like.

Referring to FIG. 1, an electrochemical cell 100 according to an embodiment includes an electrode assembly 40 manufactured by winding a separator 30 interposed between a positive electrode 10 and a negative electrode 20, and a case 50 housing the electrode assembly 40. An electrolyte (not shown) may be impregnated in the positive electrode 10, the negative electrode 20, and the separator 30.

The separator 30 is the same as described above.

The positive electrode 10 may include a positive current collector and a positive active material layer formed on the positive current collector. The positive active material layer may include a positive active material, a binder, and optionally a conductive material.

The positive current collector may use aluminum (Al), nickel (Ni), and the like, but is not limited thereto.

The positive active material may use a compound being capable of intercalating and deintercalating lithium. Specifically, as the positive active material, at least one of a composite oxide or a composite phosphate of a metal selected from cobalt, manganese, nickel, aluminum, iron, or a combination thereof and lithium may be used. For example, the positive active material may be a lithium cobalt oxide, a lithium nickel oxide, a lithium manganese oxide, a lithium nickel cobalt manganese oxide, a lithium nickel cobalt aluminum oxide, a lithium iron phosphate, or a combination thereof.

The binder improves binding properties of positive active material particles with one another and with a current collector, and specific examples may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. These may be used alone or as a mixture of two or more.

The conductive material improves conductivity of an electrode and examples thereof may be natural graphite, artificial graphite, carbon black, a carbon fiber, a metal powder, a metal fiber, and the like, but are not limited thereto. These may be used alone or as a mixture of two or more. The metal powder and the metal fiber may use a metal of copper, nickel, aluminum, silver, and the like.

The negative electrode 20 includes a negative current collector and a negative active material layer formed on the negative current collector.

The negative current collector may use copper (Cu), gold (Au), nickel (Ni), a copper alloy and the like, but is not limited thereto.

The negative active material layer may include a negative active material, a binder, and optionally a conductive material.

The negative active material may be a material that reversibly intercalates/deintercalates lithium ions, a lithium metal, a lithium metal alloy, a material being capable of doping and dedoping lithium, a transition metal oxide, or a combination thereof.

The material that reversibly intercalates/deintercalates lithium ions may be a carbon material which is any generally-used carbon-based negative active material, and examples thereof may be crystalline carbon, amorphous carbon, or a combination thereof. Examples of the crystalline carbon may be may be graphite such as amorphous, sheet-shape, flake, spherical shape or fiber-shaped natural graphite or artificial graphite. Examples of the amorphous carbon may be soft carbon or hard carbon, a mesophase pitch carbonized product, fired coke, and the like. The lithium metal alloy may be an alloy of lithium and a metal selected from the group consisting of Na, K, Rb, Cs, Fr, Be, Mg, Ca, Sr, Si, Sb, Pb, In, Zn, Ba, Ra, Ge, Al, and Sn. The material being capable of doping and dedoping lithium may be Si, SiOₓ (0<x<2), a Si—C composite, a Si—Y alloy, Sn, SnO₂, a Sn—C composite, a Sn—Y alloy, and the like, and at least one of these may be mixed with SiO₂. Specific examples of the element Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof. The transition metal oxide may be vanadium oxide, lithium vanadium oxide, and the like.

The binder and the conductive material used in the negative electrode may be the same as the binder and conductive material of the positive electrode.

The positive electrode and the negative electrode may be manufactured by mixing each active material composition including each active material and a binder, and optionally a conductive material in a solvent, and coating the active material composition on each current collector. Herein, the solvent may be N-methylpyrrolidone, and the like, but is not limited thereto. The electrode manufacturing method is well known, and thus is not described in detail in the present specification.

The electrolyte solution includes an organic solvent a lithium salt.

The organic solvent serves as a medium for transmitting ions taking part in the electrochemical reaction of a cell. Specific examples thereof may be selected from a carbonate-based solvent, an ester-based solvent, an ether-based solvent, a ketone-based solvent, an alcohol-based solvent, and an aprotic solvent.

Examples of the carbonate based solvent may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like. Specifically, when a linear carbonate compound and a cyclic carbonate compound are mixed, a solvent having a high dielectric constant and a low viscosity may be provided. Herein, the cyclic carbonate compound and the linear carbonate compound may be mixed together in a volume ratio ranging from 1:1 to 1:9.

Examples of the ester-based solvent may be methylacetate, ethylacetate, n-propylacetate, dimethylacetate, methylpropionate, ethylpropionate, γ-butyrolactone, decanolide, valerolactone, mevalonolactone, caprolactone, and the like. Examples of the ether-based solvent may be dibutylether, tetraglyme, diglyme, dimethoxyethane, 2-methyltetrahydrofuran, tetrahydrofuran, and the like. Examples of the ketone-based solvent may be cyclohexanone, and the like and the alcohol-based solvent may be ethanol, isopropyl alcohol, and the like.

The organic solvent may be used alone or in a mixture, and when the organic solvent is used in a mixture, the mixture ratio may be controlled in accordance with a desirable cell performance.

The lithium salt is dissolved in an organic solvent, supplies lithium ions in a cell, basically operates an electrochemical cell, and improves lithium ion transportation between positive and negative electrodes therein.

Examples of the lithium salt may be LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) wherein, x and y are natural numbers, LiCl, LiI, LiB(C₂O₄)₂, or a combination thereof.

The lithium salt may be used in a concentration ranging from 0.1 M to 2.0 M. When the lithium salt is included within the above concentration range, an electrolyte solution may have excellent performance and lithium ion mobility due to optimal electrolyte conductivity and viscosity.

Hereinafter, Preparation Examples, Examples, Comparative Examples, and Experimental Examples are described and thereby the present invention is described in more detail. However, Preparation Examples, Examples, Comparative Examples, and Experimental Examples are examples of the present invention and the disclosure of the present invention is not limited thereto.

### EXAMPLE

### Preparation Example 1: Preparation of Polyphosphonate Precursor A

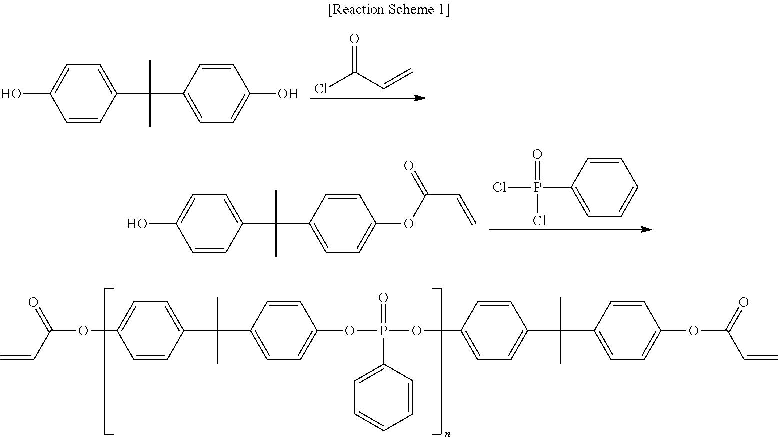

Bisphenol A (68.48 g, 300 mmol) and triethylamine (75.9 g, 750 mmol) were added into methylene chloride (1 L) and then cooled at 0° C. A solution that 13.57 g (150 mmol) of acrylic chloride was dissolved in 100 mL of methylene chloride was slowly added for 1 hour and then reacted at a room temperature for 4 hours. After cooling the reactant at 0° C. again, a solution that 29.24 g (150 mmol) of phenylphosphonic dichloride (benzene phosphorus oxydichloride, BPOD) was dissolved in methylene chloride (100 mL) was slowly added for 1 hour and then reacted at a room temperature for 4 hours. The reaction-completed solution was cleaned by a diluted HCl solution and distilled water for several times. The cleaned polymer precursor A was dried in a vacuum oven at 80° C. for 48 hours.

### Preparation Example 2: Preparation of Polyphosphonate Precursor B

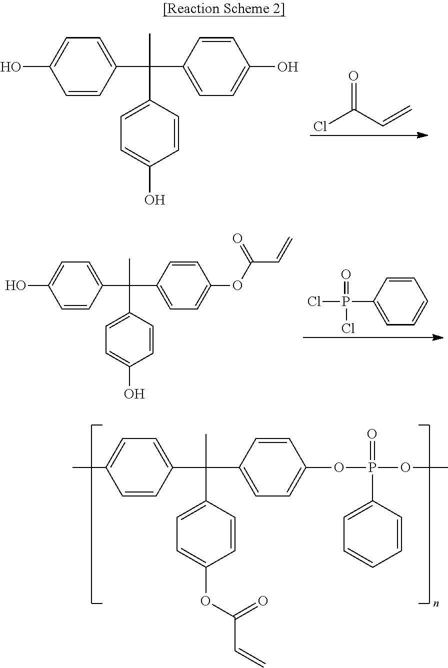

Tris (4-hydroxyphenyl)ethane (91.98 g, 300 mmol) and triethylamine (146.3 g, 1050 mmol) ware added into methylene chloride (1 L) and then cooled at 0° C. A solution that 27.15 g (300 mmol) of acrylic chloride was dissolved in methylene chloride (100 mL) was slowly added for 1 hour and then reacted at a room temperature for 4 hours. The reactant was cooled at 0° C. again. Then a solution that 58.49 g (300 mmol) of phenylphosphonic dichloride (benzene phosphorus oxydichloride, BPOD) was dissolved in methylene chloride (100 mL) was slowly added for 1 hour and then reacted at a room temperature for 4 hours. The reaction-completed solution was cleaned by a diluted HCl solution and distilled water for several times. The cleaned polymer precursor B was dried in a vacuum oven at 80° C. for 48 hours.

### Example 1: Preparation of Separator Including Heat Resistant Porous Layer

Using the polymer precursor A prepared in Preparation Example 1 and pentaerythritol tetra acrylate, a heat resistant porous layer composition was prepared. 9.5 g of the obtained polymer precursor A and 0.5 g of pentaerythritol tetra acrylate (PE044) were dissolved in 90 g of acetone to provide a 10 wt % solution. After mixing 37.5 g of 25 wt % alumina/acetone mixed solution with 22.5 g of the obtained 10 wt % solution, 0.2 g of benzoyl peroxide, 25 g of acetone were added to provide a heat resistant porous layer composition. The obtained heat resistant porous layer composition was coated on both surfaces of a polyethylene single layer substrate film having a thickness of 7 μm by a dip coating method and followed by a high temperature aging at 90° C. for 24 hours to provide a separator according to Example 1 having a thickness of 11 μm.

### Example 2: Preparation of Separator Including Heat Resistant Porous Layer

A separator according to Example 2 was obtained in accordance with the same procedure as in Example 1, except that the polymer precursor A and the pentaerythritol tetra acrylate were used in 7.5 g, 2.5 g, respectively, from Example 1.

### Example 3: Preparation of Separator Including Heat Resistant Porous Layer

A separator according to Example 3 was obtained in accordance with the same procedure as in Example 1, except that the polymer precursor A and the pentaerythritol tetra acrylate were used in 5 g, 5 g, respectively, from Example 1.

### Example 4: Preparation of Separator Including Heat Resistant Porous Layer

A separator according to Example 4 was obtained in accordance with the same procedure as in Example 1, except that the polymer precursor A and the pentaerythritol tetra acrylate were used in 2.5 g, 7.5 g, respectively, from Example 1.

### Example 5: Preparation of Separator Including Heat Resistant Porous Layer

A separator according to Example 5 was obtained in accordance with the same procedure as in Example 1, except that 10 g of the polymer precursor B obtained from Preparation Example 2 was used instead of the polymer precursor A and the pentaerythritol tetra acrylate from Example 1.

### Example 6: Preparation of Separator Including Heat Resistant Porous Layer

A separator according to Example 6 was obtained in accordance with the same procedure as in Example 1, except that 10 g of the polymer precursor A was used instead of the polymer precursor A and the pentaerythritol tetra acrylate from Example 1.

### Comparative Example 1: Preparation of Separator Including Heat Resistant Porous Layer

10 g of pentaerythritol tetra acrylate was dissolved in 90 g of acetone to provide a 10 wt % solution. 37.5 g of a 25 wt % alumina/acetone mixed solution was mixed with 22.5 g of the obtained 10 wt % solution and then added with 0.2 g of benzoyl peroxide, 25 g of acetone to provide a heat resist layer composition. The obtained heat resist layer composition was coated on both surfaces of a polyethylene single layer substrate film having a thickness of 7 μm by a dip coating method and followed by a high temperature aging at 90° C. for 24 hours to provide a separator according to Comparative Example 1 having a thickness of 11 μm.

### Experimental Example

The separators obtained from Examples 1 to 6 and Comparative Example 1 were measured for air permeability, electrolyte solution shrinkage, puncture strength, and flame retardancy in accordance with the following measuring methods, and the results are shown in Table 1.

TABLE 1

| | | | | | | Electrolyte | | |
|---|---|---|---|---|---|---|---|---|
| | | | | | | solution | | |
| | | | | Coating | Air | shrinkage | Puncture | |
| | | | | thickness | permeability | (150° C., 60 min) | strength | Flame |
| | Precursor A | Precursor B | PE044 | (μm) | (sec/100 cc) | (%), MD/TD | (gf) | retardancy |
| Example 1 | 95 | — | 5 | 4 | 289 | 32/28 | 629 | V-0 |
| Example 2 | 75 | — | 25 | 4 | 303 | 28/26 | 646 | V-0 |
| Example 3 | 50 | — | 50 | 4 | 370 | 9/10 | 647 | V-2 |
| Example 4 | 25 | — | 75 | 4 | 307 | 12/10 | 644 | V-2 |
| Example 5 | — | 100 | — | 4 | 290 | 10/12 | 635 | V-0 |
| Example 6 | 100 | — | — | 4 | 289 | 41/38 | 629 | V-0 |
| Comparative | — | — | 100 | 4 | 295 | 58/52 | 635 | Fail |
| Example 1 | | | | | | | | |

### Experimental Example 1: Measurement of Air Permeability

The separators obtained from Examples 1 to 6 and Comparative Example 1 were measured for air permeability by measuring the time (sec) that it takes 100 cc of air to pass through the separators using EG01-55-1MR (Asahi Seiko Co., Ltd.).

### Experimental Example 2: Measurement of Electrolyte Solution Shrinkage

The separators obtained from Examples 1 to 6 and Comparative Example 1 were measured for an electrolyte solution shrinkage in accordance with the following method:

Each of the separators obtained from Examples and Comparative Example was cut into width (MD) 5 cm×length (TD) 5 cm to provide total 7 specimens. Each the specimen was dripped with 1 ml of an electrolyte solution of 1.15M LiPF₆, EC/EMC/DEC=3/5/2 and then stored in a chamber at 150° C. for 60 minutes, and then the lengths of a MD direction and a TD direction of the specimen before and after the storage were measured, and followed by measuring how it was shrank therefrom to calculate an electrolyte solution shrinkage (%).

### Experimental Example 3: Measurement of Puncture Strength

In order to measure a puncture strength of separators obtained from Examples 1 to 6 and Comparative Example 1, the following test was performed.

Each of the separators was cut into width (MD) 50 mm×length (TD) 50 mm at 10 different regions to obtain 10 specimens, and then the specimen was placed over a 10 cm hole using GATO Tech G5 equipment and followed by measuring puncturing force while pressing down using a 1 mm probe. The puncture strength of each specimen was measured for each three times, and then the average thereof was calculated.

### Experimental Example 4: Measurement of Flame Retardancy

Specimens were fabricated from the separators obtained from Examples 1 to 6 and Comparative Example 1 and evaluated for a flame retardancy according to UL94 VB flame retardance regulations.

The separator of 10 cm×50 cm was folded into 10 cm×2 cm, and the upper end and lower parts were fixed to provide a specimen. According to UL94 VB, the flame retardant rate was measured based on a combusting time of the specimen.

While specific parts of the present invention was detailed described in above, the person having ordinary skills in the art may clearly understand that the specific descriptions are only exemplary embodiments, and the scope of the present invention is not limited thereto. Accordingly, the substantial scope of the present invention shall be determined only according to the attached claims and the equivalents thereof.

1. A separator comprising
a porous substrate and
a heat resistant porous layer on one or both surfaces of the porous substrate, wherein the heat resistant porous layer comprises a cross-linked product of a cross-linkable functional group-containing phosphate-based or phosphonate-based monomer, oligomer, or polymer.

2. The separator of claim 1, wherein the cross-linkable functional group-containing phosphate-based or phosphonate-based monomer, oligomer, or polymer is a compound of Chemical Formula 1 or Chemical Formula 2. 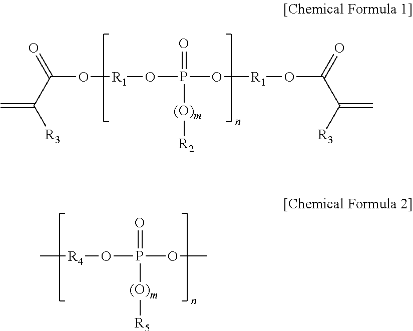
wherein, in Chemical Formula 1 or 2,
R₁ and R₄ are independently selected from a substituted or unsubstituted, C₁₋₁₈ alkylene, C₂₋₆ alkenylene, C₃₋₁₂ cycloalkylene, and C₆₋₃₀ aromatic containing group,
R₂, R₃, and R₅ are independently selected from a substituted or unsubstituted, hydrogen, C₁₋₁₈ alkyl, C₂₋₆ alkenyl, C₃₋₁₂ cycloalkyl, C₆₋₃₀ aromatic containing group, and halogen atom,
n is an integer ranging from 1 to 1000, and
m is 0 or 1.

3. The separator of claim 2, wherein in Chemical Formula 1 or Chemical Formula 2, R₁ and R₄ are independently a substituted or unsubstituted C₆₋₃₀ aromatic containing group, R₂ is a substituted or unsubstituted C₆₋₃₀ aromatic containing group or halogen atom, and R₃ is a substituted or unsubstituted, hydrogen, or C₁₋₁₈ alkyl, or halogen atom.

4. The separator of claim 2, wherein in Chemical Formula 2, the cross-linkable functional group is introduced into at least one of each substituent of R₄ and R₅.

5. The separator of claim 1, wherein the cross-linked product is a cross-linked product of the cross-linkable functional group-containing phosphate-based or phosphonate-based monomer, oligomer, or polymer with a multi-functional (meth)acrylate.

6. The separator of claim 5, wherein the multi-functional (meth)acrylate is (meth)acrylate including two or more functional groups selected from a vinyl group, an epoxy group, and a hydroxyl group.

7. The separator of claim 1, wherein the porous substrate is a polyolefin-based porous substrate.

8. The separator of claim 1, wherein the heat resistant porous layer further includes an inorganic particle.

9. The separator of claim 8, wherein the inorganic particle comprises one or more selected from the group consisting of Al₂O₃, SiO₂, B₂O₃, Ga₂O₃, TiO₂, and SnO₂.

10. The separator of claim 1, wherein the heat resistant porous layer further comprises a polymer resin in addition to the cross-linked product.

11. A separator comprising
a porous substrate; and
a heat resistant porous layer formed on one or both surfaces of the porous substrate,
wherein an electrolyte solution shrinkages of the separator at a width direction and a length direction at 150° C. and 60 minutes are each less than or equal to 45%, and
a flame retardancy is greater than or equal to V2 according to UL94 VB flame-retardance regulations.

12. The separator of claim 11, wherein air permeability of the separator is less than or equal to 400 sec/100 cc.

13. A method of preparing a separator, comprising
preparing a heat resistant porous layer composition comprising a cross-linkable functional group-containing phosphate-based or phosphonate-based monomer, oligomer, or polymer, a polymerization initiator, and a solvent, and
coating the heat resistant porous layer composition on one or both surfaces of the porous substrate and performing a cross-linking reaction to form a heat resistant porous layer.

14. The method of claim 13, wherein the cross-linkable functional group-containing phosphate-based or phosphonate-based monomer, oligomer, or polymer is a compound of Chemical Formula 1 or 2. 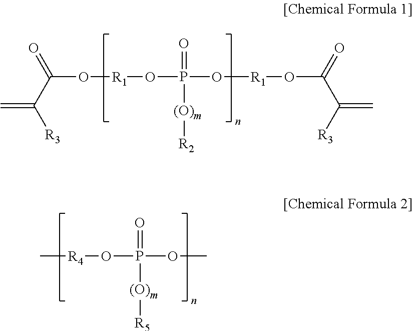
wherein, in Chemical Formula 1 or 2,
R₁ and R₄ are independently selected from a substituted or unsubstituted, C₁₋₁₈ alkylene, C₂₋₆ alkenylene, C₃₋₁₂ cycloalkylene, and C₆₋₃₀ aromatic containing group,
R₂, R₃, and R₅ are independently selected from a substituted or unsubstituted, hydrogen, C₁₋₁₈ alkyl, C₂₋₆ alkenyl, C₃₋₁₂ cycloalkyl, C₆₋₃₀ aromatic containing group, and halogen atom,
n is an integer ranging from 1 to 1000, and
m is 0 or 1.

15. The method of claim 13, wherein the heat resistant porous layer composition further comprises a multi-functional (meth)acrylate.

16. The method of claim 15, wherein the multi-functional (meth)acrylate is a (meth)acrylate having two or more functional groups selected from a vinyl group, an epoxy group, and a hydroxyl group.

17. The method of claim 13, wherein the cross-linking reaction is thermal curing, photo-curing, or high humidity and high temperature curing.

18. An electrochemical cell comprising a positive electrode, a negative electrode, a separator and an electrolyte, wherein the separator comprises the separator of claim 1.

19. The electrochemical cell of claim 18, wherein the electrochemical cell is a lithium rechargeable cell.

20. An electrochemical cell comprising a positive electrode, a negative electrode, a separator and an electrolyte, wherein the separator comprises the separator of claim 12.
